(19) United States
(12) Patent Application Publication
(10) Pub. No.: US 2010/0235198 A1
(43) Pub. Date: Sep. 16, 2010

(54) Synchronous insurance inspection and valuation

(76) Inventors: Jim Fini, Natick, MA (US); Jerry S. Straughan, JR., Newton, MA (US)

Correspondence Address: KRISTOFER E. ELBING, 187 PELHAM ISLAND ROAD, WAYLAND, MA, 01778, US

(21) Appl. No.: 12/380,402

(22) Filed: Feb. 25, 2009

Related U.S. Application Data
(60) Provisional application No. 61/067,065, filed on Feb. 25, 2008.

(51) Int. Cl. G06Q 40/00; G06Q 10/00; G06K 7/00

(52) U.S. Cl. 705/4; 705/306; 235/435

(57) ABSTRACT

Disclosed in one general aspect is an insurance item valuation method that includes establishing a communication link between a location in an operations base and a field site and transmitting item identification information about a series of different discrete items in different item categories located at the field site through the communications link. Insurance valuation information about the items is accessed at the operations base, and an acknowledgement about the insurance valuation information is transmitted from the operations base to the field site.

This application claims the benefit under 35 U.S.C. 119(e) of U.S. provisional application Ser. No. 61/067,065 filed Feb. 25, 2008 which is herein incorporated by reference.

### FIELD OF THE INVENTION

This application relates to insurance inspection and valuation for underwriting and claims.

### BACKGROUND OF THE INVENTION

Referring to FIG. 8A, prior art contents insurance claims have typically been processed through a multi-part approach. This approach generally begins with a handwritten or dictated content inventory that is usually produced by the insured and an inspector/adjuster at the claim site. A transcriptionist typically then transcribes the inventory into a computer, and the inspector reviews the resulting transcribed inventory. If it is incomplete, which might be caused by noisy dictation environment, for example, the inspector/appraiser may need to return to the claim site and/or re-interview the insured.

Once the inventory is complete and accurate, an inspector/appraiser can begin researching and appraising the insured contents. One or more subject matter experts may also be needed to research and appraise more specialized items, such as artwork, antiques, or collectibles. They may also need to visit the claim site or re-interview the insured, such in the case where an original inspector/adjustor did not provide an adequate description of specialized contents. Once all items have been appraised, the adjuster usually consolidates all appraisals into a single estimate and applies depreciation, tax, and policy limits to this estimate. He or she can then negotiate with the insured to settle the claim.

### SUMMARY OF THE INVENTION

In one general aspect, the invention features an insurance item valuation method that includes establishing a communication link between a location in an operations base and a field site and transmitting item identification information about a series of different discrete items in different item categories located at the field site through the communications link. Insurance valuation information about the items is accessed at the operations base, and an acknowledgement about the insurance valuation information is transmitted from the operations base to the field site.

In preferred embodiments, the step of establishing can establish a communication link that is capable of voice and data communication and the step of transmitting information can include transmitting a voice description of the insured item and an image of the item. The step of transmitting an acknowledgement can include transmitting the valuation information in a digital format. The step of establishing can establish a voice communication link between a field-based inspector/adjuster and an appraiser at the operations base. The step of establishing can establish a voice communication link between a field-based inspector/adjuster and a transcriptionist at the operations base. Where the memory can further include the step of compiling a list of the items and the valuation information corresponding to those items accessed in the step of accessing. The step of compiling can insert live links to external data sources for at least some of the items. The step of transmitting an acknowledgement for an item can take place before the step of transmitting information for a next item. The step of transmitting item identification information can include transmitting item attributes in an item-specific predetermined order. The step of accessing valuation information accesses a database of items that is organized based on different predetermined orderings for different categories of items. The method can further include one further step of transmitting item identification information, accessing valuation information, and transmitting acknowledgements for each of the further communication links. The step of accessing can access a specialized insurance valuation database organized by categories of items. The step of accessing accesses stored replacement and refurbishment costs for the items. The step of accessing accesses stored replacement and refurbishment sources for the items.

In another general aspect, the invention features an insurance valuation system that includes an operations base workstation including: an operations base communication terminal, and an operations base communication interface responsive to the operations base communication terminal, an item valuation search system. A field communication unit is located outside of the operations base, and includes a field communication terminal, a field communication interface responsive to the field communication terminal and operatively connected to the operations base communication interface, and item list storage responsive to one of the communication terminal of the field communication and the item valuation and the operations base workstation.

In preferred embodiments, the field communication terminals can include an image acquisition interface. The field communication terminal can includes a code reader.

In a further general aspect, the invention features a memory for storing data for access by an insurance valuation access program that includes a plurality of insurance item valuation records for a plurality of different types of items. Each valuation record includes at least a first attribute specifier for that category of insured item, a first weight for that category of insured item, a second attribute specifier that category of insured item, and a second weight for that category of insured item.

In preferred embodiments, the memory can further include a preferred attribute order specifier associated with each of the different categories of items. The attributes can include brand and model attributes or a machine-readable product code. The attribute specifiers and the preferred access orders can be derived from a statistical analysis of valuation data sources.

In another general aspect, the invention features an insured item valuation system that includes an insurance provider client system, an insured valuation access interface in communication with the insurance provider client system and accessible by an insured, a display area for presenting valuation information for items for insurance purposes, and a feedback control responsive to interaction by the insured to provide feedback information related to the valuation information for at least one of the items.

In preferred embodiments, the display area can present links to valuation source information for at least some of the items. The valuation access interface can be a web-based interface. The insured valuation access interface can be a claim-based interface, with the feedback control being operative to accept or dispute valuation information presented in the display area for at least one of the items.

In a further general aspect, the invention features a memory for storing data for access by an insurance valuation access program that includes a temporal identifier that specifies a time for a field visit, site location information for the field visit, contact information for a communication link to be set up during the field visit between an operations base and the field site, and a claim identifier.

Systems according to the invention may be advantageous in that they can significantly shorten and/or improve the quality of the process of contents insurance valuation for claims or underwriting purposes. Such systems can prevent agents from returning to a claim or underwriting location to gather information that could have been obtained the first time. This can avoid wasted time on the part of agents, and can result in a faster resolution of a claim or a faster coverage quote. Systems according to the invention may even be capable of producing fully automated and/or on-the-spot valuation reports.

### BRIEF DESCRIPTION OF THE DRAWINGS

FIG. 1 is a block diagram showing parts of an illustrative synchronous valuation system according to the invention;

FIG. 2 is a block diagram showing additional parts of an illustrative synchronous valuation system according to the invention;

FIG. 3 is a block diagram showing further parts of an illustrative synchronous valuation system according to the invention;

FIG. 4 is a block diagram showing an illustrative valuation event data structure for use with a system such as the one shown in FIGS. 1-3;

FIG. 5 is a block diagram showing an illustrative item valuation data structure for use in generating a taxonomy with a system such as the one shown in FIGS. 1-3;

FIG. 6 is a block diagram showing an illustrative optimized item valuation data structure for use in performing valuations with a system such as the one shown in FIGS. 1-3;

FIG. 7 is a flowchart illustrating operations performed by the system of FIG. 1-3;

FIG. 8A is a flowchart showing a prior art valuation process;

FIG. 8B is a flowchart illustrating a process that can be implemented with an embodiment of the system shown in FIGS. 1-3;

FIG. 9 is a screenshot of a valuation interface that can be implemented for an embodiment of the illustrative synchronous valuation system shown in FIGS. 1-3; and

FIG. 10 is an illustrative report from an illustrative synchronous valuation system such as the one shown in FIGS. 1-3.

### DESCRIPTION OF AN ILLUSTRATIVE EMBODIMENT

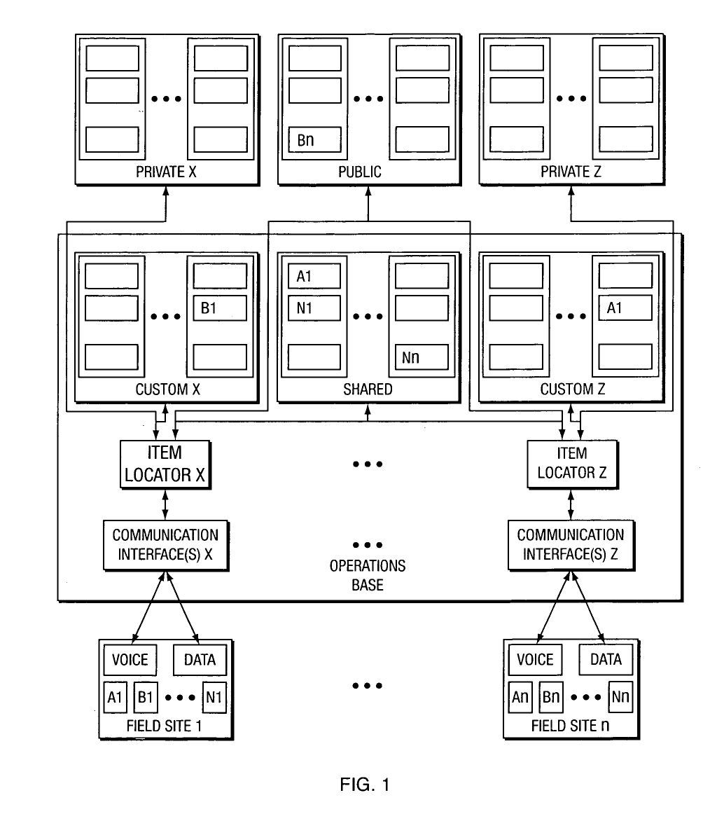

Referring to FIG. 1, an illustrative embodiment of a synchronous valuation system is based on an operations base and one or more field units. The operations base can be centralized in a single office building, or it can be distributed over a number of locations, which can include home-based telecommuter offices. The field units are each deployed to a respective claim location.

The operations base is linked to each of the field units via a communications link, such as a telephone line, a wireless telephone channel, and/or a computer network connection. The operations base also includes item locators, which are preferably computerized and provide access to a variety of different data valuation sources. These sources can be developed privately or available publically, and may or may not be available to all of the item locators.

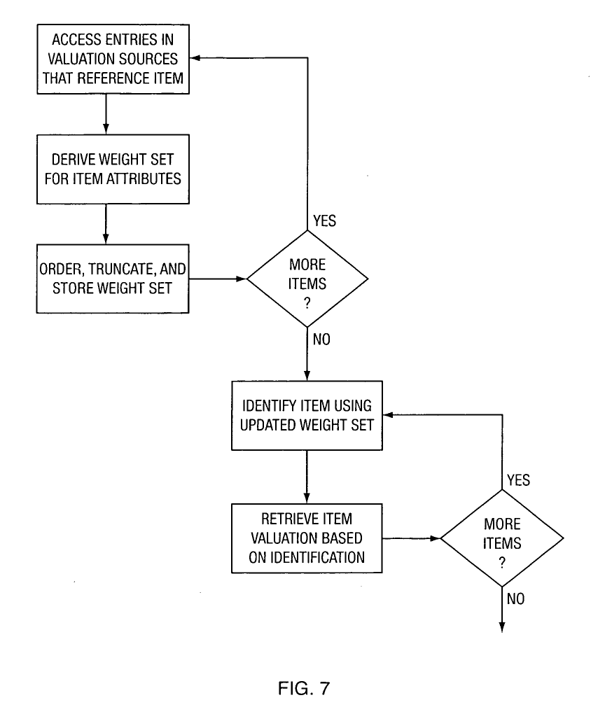

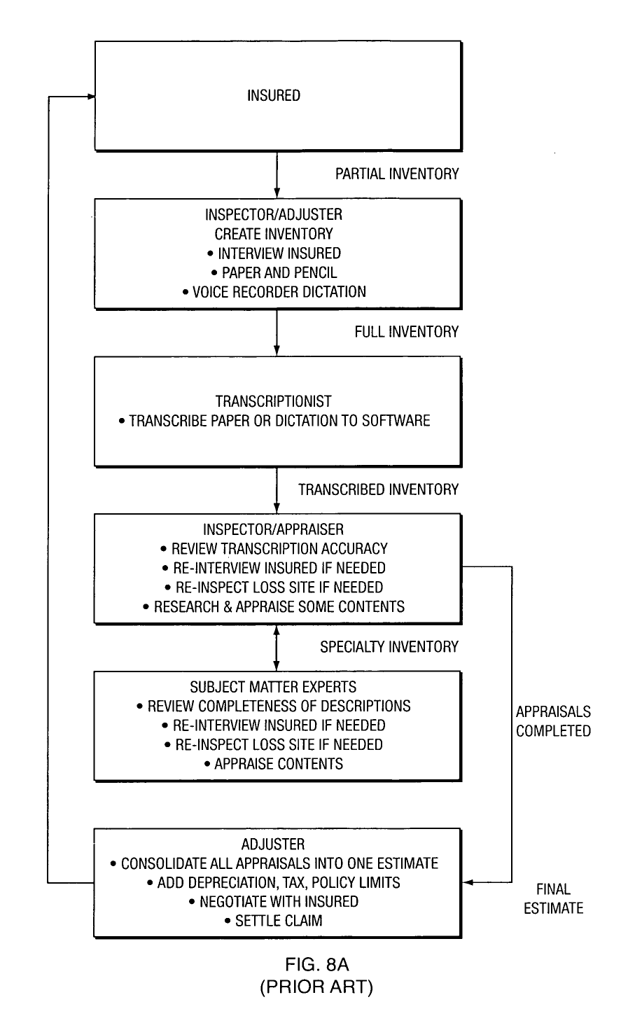

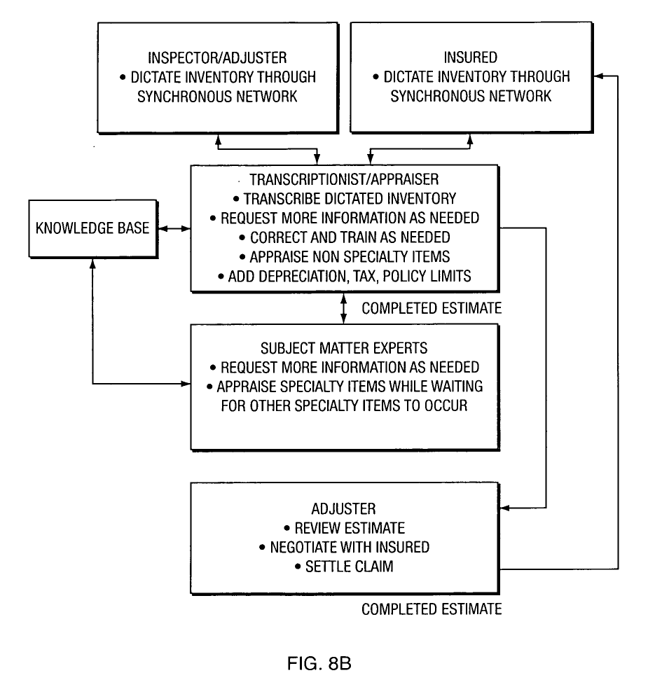

The system can employ different levels of automation. In one embodiment presented in FIG. 7B, an inspector/adjuster is equipped with a wireless device that has telephonic, electronic mail, and image acquisition capabilities. He or she is sent to inspect a claim site and calls an appraiser at the operations base. During the inspection, the inspector/adjuster synchronously relays his findings via voice, e-mail, and/or photos taken at the claim site.

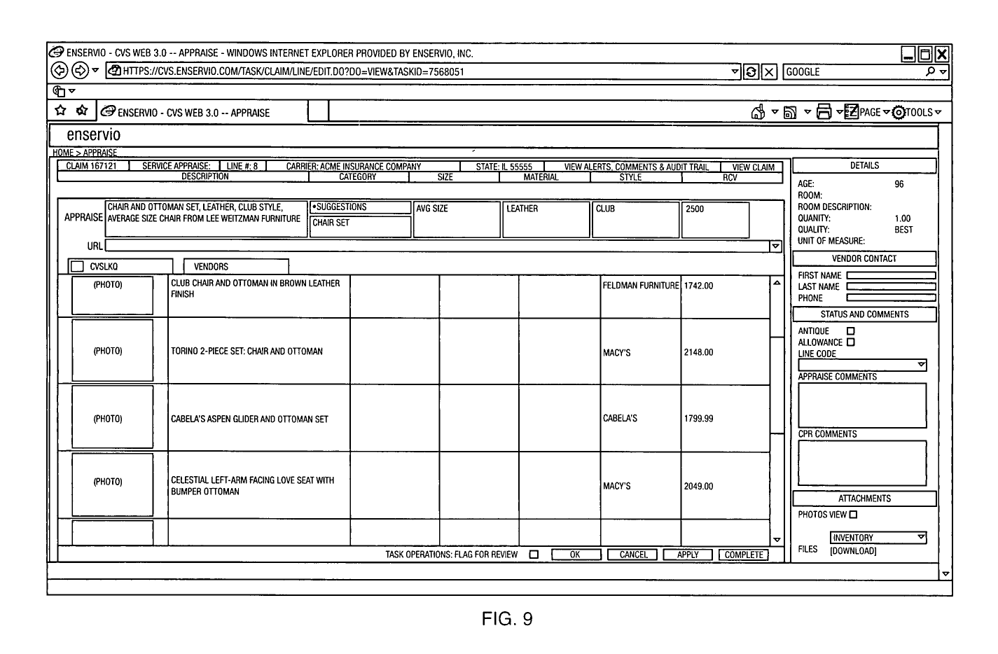

The appraiser receives the inspector/adjuster's findings and uses the item locator to locate refurbishment prices for items that can be refurbished or replacement (purchase) prices for items that are beyond refurbishment for the claim while the inspector is at the claim site (see FIG. 9). Often, replacement valuations can be found at electronic commerce sites on the interne, although other types of valuations sites, such as art appraisal sites, or an appraiser's custom database, can also be consulted. Also, refurbishment prices are also available from private sources, usually repair/restoration service providers local to the insured. As the appraiser locates item valuations, the system builds and stores a list of them. This list can include a replacement value for each item as well as a replacement source for that item. In one embodiment, the list entries can each include a link, such as a URL, to an item page on public replacement source.

Providing replacement and repair/refurbishment valuations in response to a single inspection is advantageous in that it can greatly speed up the valuation process while keeping overall cost to a minimum.

If an appraiser is not able to appraise an item, he or she may bring in a subject matter expert. This person can be consulted in a variety of ways, such as by telephone, e-mail, or in a conference call. The inspector/adjuster can also be routed to the expert without the appraiser remaining on the call.

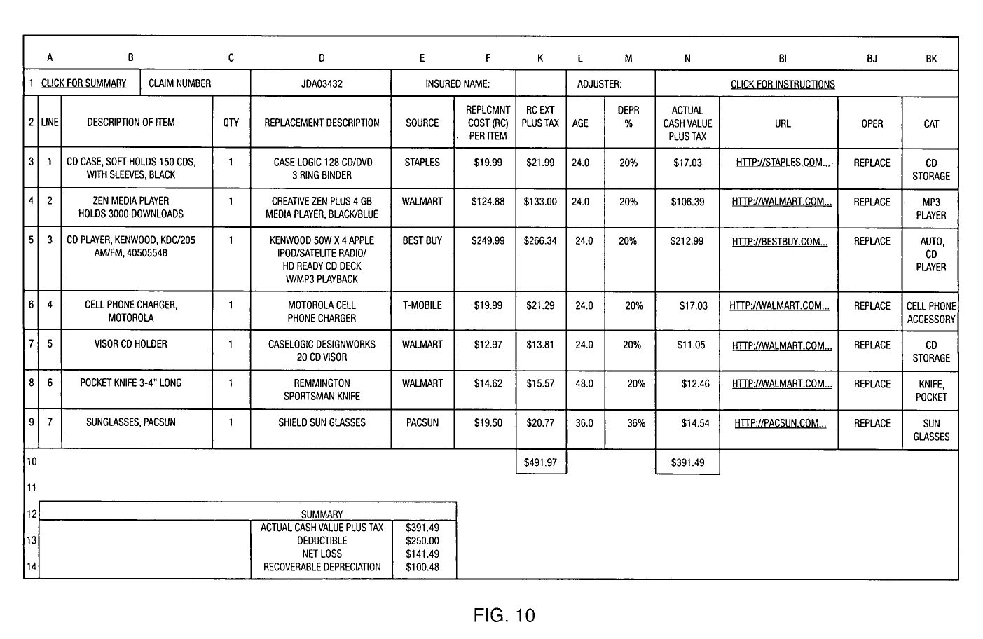

Appraisers or subject matter experts can ask for more information, such as a photo, for a particular item, and the inspector/adjuster can provide the needed information during his visit. Items can be processed one at a time, with the appraiser performing a full lookup before another item is discussed, or the list can be built and processed in a more flexible way. Once all of the items have been researched, a final valuation report can be generated and provided to an adjuster or even the insured (see FIG. 10).

Some or all of the information about the items can be sent back to the inspector/adjuster. He or she can use this information to help evaluate an item (does it look more like photo A or photo B?). Some or all of the valuation information can also be communicated to the insured at the field location.

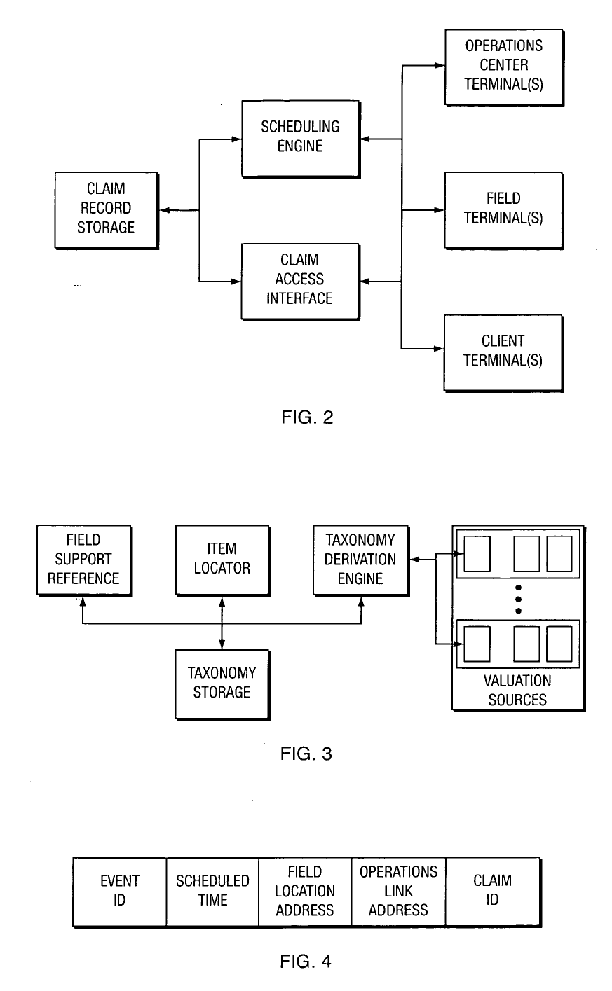

Referring to FIGS. 1-2, other embodiments can use additional levels of automation. Instead of interacting with a human appraiser, for example, the inspector/adjuster can interact with an Interactive Voice Recognition (IVR)—based or web-based locator system through a communication device in the field for some or all of the items. The insured might in some cases also perform some or all of the inventory data gathering, such as by filling out a web form or transmitting photographs to the operations base through an automated claim access interface. And a final valuation report with live links can be provided to the insured so that he or she can check the valuations used in the report. This report can provide an acceptance/dispute control that allows the insured to accept or dispute a valuation.

Referring also to FIG. 4, the system can optionally manage inspection scheduling. In this case, a scheduling engine generates an appointment record that can be sent to the appraiser, inspector/adjuster, and/or the insured, such as by e-mail. This record includes fields that are to be used in connection with an inspection/valuation event, and can include an event ID, a date/time for the meeting, a field location address, an operations link address, and a claim ID. The information fields can be used to help automate inspection setup, such as by providing the basis for an electronic reminder, for automated maps/directions to the claim location, or for automatic communication link setup.

Referring to FIGS. 3 and 5-7, the system preferably uses an optimized item taxonomy that helps to streamline the valuation process. This taxonomy divides items into categories and provides an efficient set of attributes for each category. It is derived by a taxonomy engine from valuation sources and stored in taxonomy storage for access by the item locators and/or field terminals.

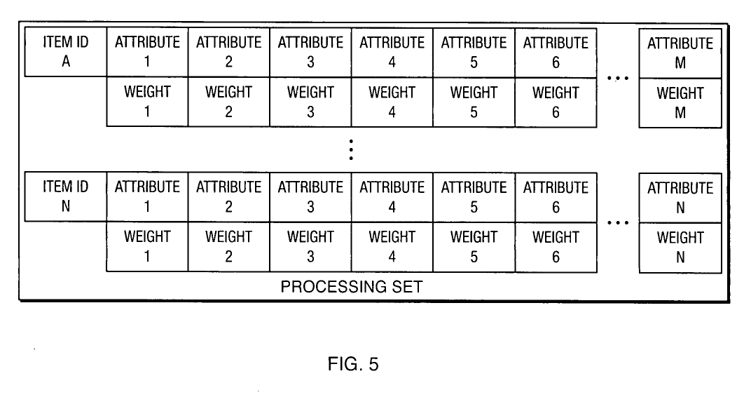

Referring to FIG. 5, the taxonomy engine searches the valuation sources or a valuation index for each item category A . . . n to generate an exhaustive list of attributes that could affect its value. For a given category, for example, these attributes might include: size, material, style, country of origin, color, etc. Weights are also derived for each of the attributes to determine how strongly they affect price. Size and material may have a significant effect on the price of table, for example, but color is likely to have little.

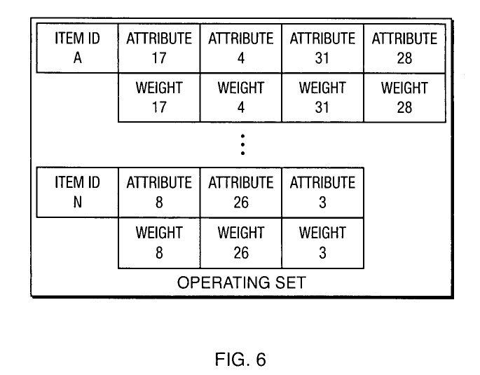

Referring to FIG. 6, the taxonomy engine collapses the larger set of attribute-weight pairs into a smaller operating set. This process reorders the attributes in order of descending weight, and truncates the number of attributes. For a table, for example, only country of origin, size and material might be kept. It has been found that 4-6 attributes is frequently sufficient to characterize a category of items.

The system preferably includes learning capabilities to optimize its taxonomy as claims are processed. For example, the system preferably learns attributes of items in addition to their brands and model numbers and/or UPC codes. This allows specific models or UPC codes to be used to access item attributes for discontinued items.

In one embodiment, to obtain Category Attribute Weights (CAWs) which influence weights, Enservio employs a Bayesian network model to correlate keywords comprising a search query with a knowledge base containing all previously processed keywords and keyword combinations and their mutual correlation with price for each line processed by the system. This application of Bayesian modeling is a standard approach used in search engines to measure conditional independencies of a set of variables or their causal connections. This approach is used both in a category inference process, the correlation of keywords to category attributes, and the correlation of the individual keywords and keyword combinations on price.

The taxonomy provides a highly efficient way of working with valuation. It allows an inspector/adjustor can learn to quickly provide the most important attributes to an appraiser in order during a call from a field site. It can also provide the basis for a highly efficient set of pick lists for more automated systems.

In one embodiment, an inspector/adjuster lists attributes in order based on the taxonomy and an appraiser punctuates a call with acknowledgements, such as “next item” as soon as the locator system indicates that enough information has been entered for an adequate valuation. The inspector/adjustor then goes on to the next item. This approach keeps the inspection process short and helps to ensure that sufficient valuation information is available for all items by the end of the inspection.

The system described above has been implemented in connection with a special-purpose software program running on a general-purpose computer platform, but it could also be implemented in whole or in part using special-purpose hardware. And while the system can be broken into the series of modules and steps shown in the various figures for illustration purposes, one of ordinary skill in the art would recognize that it is also possible to combine them and/or split them differently to achieve a different breakdown. In addition, as discussed above, different levels of automation can also be used in the various parts of the system.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1. An insurance item valuation method, comprising:
establishing a communication link between a location in an operations base and a field site,
transmitting item identification information about a series of different discrete items in different item categories located at the field site through the communications link,
accessing insurance valuation information about the items at the operations base, and
transmitting an acknowledgement about the insurance valuation information from the operations base to the field site.

2. The method of claim 1 wherein the step of establishing establishes a communication link that is capable of voice and data communication and wherein the step of transmitting information includes transmitting a voice description of the insured item and an image of the item.

3. The method of claim 2 wherein the step of transmitting an acknowledgement includes transmitting the valuation information in a digital format.

4. The method of claim 1 wherein the step of establishing establishes a voice communication link between a field-based inspector/adjuster and an appraiser at the operations base.

5. The method of claim 1 wherein the step of establishing establishes a voice communication link between a field-based inspector/adjuster and a transcriptionist at the operations base.

6. The method of claim 1 further including the step of compiling a list of the items and the valuation information corresponding to those items accessed in the step of accessing.

7. The method of claim 6 wherein the step of compiling inserts live links to external data sources for at least some of the items.

8. The method of claim 1 wherein the step of transmitting an acknowledgement for an item takes place before the step of transmitting information for a next item

9. The method of claim 1 wherein the step of transmitting item identification information includes transmitting item attributes in an item-specific predetermined order.

10. The method of claim 9 wherein the step of accessing valuation information accesses a database of items that is organized based on different predetermined orderings for different categories of items.

11. The method of claim 1 further including a step of transmitting tentative valuation information from the operations base to the field site via the communication link and a step of transmitting feedback about the tentative valuation information from the field site to the operations base.

12. The method of claim 1 further including a step of establishing a communication link to a second location for a subset of the items.

13. The method of claim 1 further including steps of simultaneously establishing one or more further communication links between one or more further locations in the operations base and one or more further field sites, and further including at least one further step of transmitting item identification information, accessing valuation information, and transmitting acknowledgements for each of the further communication links.

14. The method of claim 1 wherein the step of accessing accesses a specialized insurance valuation database organized by categories of items.

15. The method of claim 14 wherein the step of accessing accesses stored replacement and refurbishment costs for the items.

16. The method of claim 1 wherein the step of accessing accesses stored replacement and refurbishment sources for the items.

17. An insurance valuation system, comprising:
an operations base workstation including:
an operations base communication terminal,
an operations base communication interface responsive to the operations base communication terminal,
an item valuation search system,
a field communication unit located outside of the operations base, including:
a field communication terminal,
a field communication interface responsive to the field communication terminal and operatively connected to the operations base communication interface, and
item list storage responsive to one of the communication terminal of the field communication and the item valuation and the operations base workstation.

18. The system of claim 17 wherein the field communication terminal includes an image acquisition interface.

19. The system of claim 17 wherein the field communication terminal includes a code reader.

20. A memory for storing data for access by an insurance valuation access program, comprising:
a plurality of insurance item valuation records for a plurality of different types of items, wherein each valuation record includes at least:
a first attribute specifier for that category of insured item,
a first weight for that category of insured item.
a second attribute specifier that category of insured item, and
a second weight for that category of insured item.

21. The memory of claim 20 further including a preferred attribute order specifier associated with each of the different categories of items.

22. The memory of claim 21 wherein the attribute specifiers and the preferred access orders are derived from a statistical analysis of valuation data sources.

23. The memory of claim 20 wherein the attributes include brand and model attributes or a machine-readable product code.

24. An insured item valuation system, comprising:
an insurance provider client system,
an insured valuation access interface in communication with the insurance provider client system and accessible by an insured,
a display area for presenting valuation information for items for insurance purposes, and
a feedback control responsive to interaction by the insured to provide feedback information related to the valuation information for at least one of the items.

25. The system of claim 24 wherein the display area presents links to valuation source information for at least some of the items.

26. The system of claim 24 wherein the valuation access interface is a web-based interface.

27. The system of claim 24 wherein the insured valuation access interface is a claim-based interface and wherein the feedback control is operative to accept or dispute valuation information presented in the display area for at least one of the items.

28. A memory for storing data for access by an insurance valuation access program, comprising:
a temporal identifier that specifies a time for a field visit,
site location information for the field visit,
contact information for a communication link to be set up during the field visit between an operations base and the field site, and
a claim identifier.
